(19) United States
(12) Patent Application Publication
(10) Pub. No.: US 2024/0118203 A1
(43) Pub. Date: Apr. 11, 2024

(54) METHOD FOR REDUCING VIBRATION USING SEGMENTED ACCELERATION

(71) Applicant: Illumina, Inc., San Diego, CA (US)

(72) Inventors: Shavinesh Sukesh, San Diego, CA (US); Chia-Hsi Liu, San Diego, CA (US); Gregory Holst, San Diego, CA (US); Ahmed Okasha, San Diego, CA (US); Kurt Danielson, San Diego, CA (US); John Earney, San Diego, CA (US)

(73) Assignee: Illumina, Inc., San Diego, CA (US)

(21) Appl. No.: 18/373,592

(22) Filed: Sep. 27, 2023

Related U.S. Application Data
(60) Provisional application No. 63/411,084, filed on Sep. 28, 2022.

(51) Int. Cl. G01N 21/64

(52) U.S. Cl. CPC G01N 21/6428; G01N 2201/025; G01N 2201/068

(57) ABSTRACT

The motion of a mechanical stage may be directed in x-, y-, and/or z-dimensions such that excitation of a resonant frequency f is reduced. In particular, once a resonant frequency f is identified, the acceleration of the stage in the x-, y-, and/or z-dimensions may divided into an even number of acceleration segments or intervals, with the second of each pair of acceleration segments starting 1/(2f) seconds after the start of the initial acceleration segment. The acceleration intervals may be defined by a start time, an amplitude profile, and/or a time duration. In some implementations, the amplitude and time duration of each acceleration pulse may be different. The amplitude and time duration of acceleration steps may be determined and adjusted to compensate for the particular resonance frequency of an individual system, and programmed into a controller for the stage using motor programming controls.

### CROSS-REFERENCE TO RELATED APPLICATIONS

This application claims the benefit of U.S. Provisional Patent Application No. 63/411,084, filed Sep. 28, 2022, which is incorporated by reference herein in its entirety.

### FIELD

The present disclosure relates to mechanical control of imaging systems, and in particular, imaging systems used for rapid nucleic acid sequencing.

### BACKGROUND

In a bioassay or nucleic acid sequencing system such as systems made by ILLUMINA, Inc., flow cells containing sample material can be positioned within a sample holder on a motion stage and illuminated to induce fluorescence from a reagent that can be associated with the sample. For example, a nucleic acid sample can be flowed into the flow cell and positioned within the flow cell for analysis. A complementary nucleotide with a detectible component, such as a fluorescent dye associated with the complementary nucleotide, can associate with one or more nucleotides of the sample nucleic acid. An excitation radiation source, such as an excitation illumination source, can excite the fluorescent dye to emit a fluorescent emission. The fluorescence can be collected by an imaging system and recorded by a camera system. The motion stage may be scanned in x- and y-dimensions while image collection occurs, with a portion of the imaging system oriented in the z-dimension perpendicular to the x-y motion plane, looking down onto the flow cell. In some systems, the imaging system can also have a mechanical adjustment for the z-axis, to ensure focus of the imaging system is well controlled, as well as controls for the x- and y-axis motion of the sample stage.

The system can be mounted using a large inertial mass and a number of vibration isolators to prevent outside vibration from affecting image focus and quality. However, as with any mechanical system, mechanical resonances of the inertial mass and imaging system can occur. In particular, rapid acceleration of motion in the y-axis can cause an equal and opposite reaction for the inertial mass, and as the inertial mass may not be free to translate in the opposite y-axis direction, the energy instead may induce a rotation around the x-axis. This rotation around the x-axis also can have a motion component in the z-direction, and so the inertial mass, and the attached imaging system and camera, may also experience motion in the z-direction.

Although the imaging system may have mechanical servos to track and control focus along the z-axis, if motion on the x-y-stage excites a mechanical resonance in the inertial mass, the rocking motion may be relatively large, and the servo may be overwhelmed. This can cause the imaging system to oscillate along the z-axis, changing the focus during data collection and degrading the data quality.

Designs that reduce the coupling or dampen the z-axis vibration may be possible, but add cost, complexity, and weight to the machine. Likewise, more expensive servo systems for control of the imaging system along the z-axis may be used, but at considerably higher cost. Operations that slow the scanning to avoid exciting the resonance may reduce z-axis vibration, but may also lead to longer times to collect the data, degrading performance.

There is therefore a need to manage the x-y motions of the stage in a way that still allows rapid data collection while minimizing the excitation of resonant vibration.

### SUMMARY

This application discloses a method and a system for setting the motion of a mechanical stage in x- and y-dimensions so that the excitation of at least one resonant frequency f (in Hz) in a coupled z-dimension system is reduced. In particular, once a resonant frequency f is identified, the acceleration of the stage in the x- and/or y-dimensions is divided into an even number of acceleration segments, with the second of each pair of acceleration segments starting at approximately 1/(2f) seconds after the start of the initial acceleration segment.

While in some implementations the two pulses of a pair may be identical in amplitude and duration, in other implementations the amplitude and time duration of each acceleration pulse may be different. The amplitude and time duration of acceleration steps may be determined and adjusted to compensate for the particular resonance frequency of an individual system, and programmed into a controller for the y-axis stage, using motor programming controls. The desired acceleration of the stage may occur in the same time interval as with a single pulse, but with much reduced vibration induced in the system, improving the quality of image collection at substantially the same data collection speed or no reduction in data collection speed.

In some implementations, deceleration of the stage in the x- and y-dimensions after collecting imaging data is also divided into two deceleration segments, with the second of each pair of deceleration segments starting at approximately 1/(2f) seconds after the start of the initial deceleration segment.

In some implementations, the acceleration and/or deceleration of the stage in the x- and y-dimensions is divided into two segments, with the timing of the second segment occurring 1/(2f) seconds after the start of the first segment. However, if there are multiple resonance frequencies f₁ . . . fₙ in the system, acceleration can be divided into multiple pairs of acceleration segments, with a pair designated to have starting times 1/(2fₙ) seconds apart for each resonant frequency fₙ.

Particular aspects of the technology disclosed are described in the claims, specification and drawings.

### BRIEF DESCRIPTION OF THE DRAWINGS

FIG. 1 illustrates a 3-D perspective view of a nucleic acid sequencing system.

FIG. 2A illustrates a cross section view of a 3-D perspective view of a nucleic acid sequencing system, and FIG. 2B illustrates the system of FIG. 2B undergoing stage scanning.

FIG. 3 illustrates a schematic diagram of an example of a flow cell.

FIGS. 4A, 4B, and 4C illustrate various scan patterns that may be used for imaging flow cells.

FIG. 5 illustrates a plot of acceleration of a stage on the y-axis using a single acceleration interval, and the resulting vibration induced in the z-axis.

FIG. 6 illustrates imaging data collected from a flow cell in which the scans were initiated using a single acceleration interval, as used in FIG. 5.

FIG. 7 illustrates a plot of a single acceleration pulse as was used in FIG. 5 compared with waveform at the resonance response frequency.

FIG. 8 illustrates a plot using two structured acceleration intervals according to some implementations of the present disclosure, and plots of the induced resonance and counter-resonance waveforms.

FIG. 9 illustrates a plot of the acceleration, velocity, and position for a stage undergoing motion according to some implementations of the present disclosure.

FIG. 10 illustrates a plot of acceleration of a stage on the y-axis using a pair of acceleration intervals according to some implementations of the present disclosure, and the resulting vibration induced in the z-axis.

FIG. 11 illustrates a flow chart of a method according to an implementation of the present disclosure.

FIGS. 12A and 12B illustrate possible acceleration intervals according to some implementations of the present disclosure.

FIGS. 13A and 13B illustrate possible acceleration and deceleration intervals along with plots of the corresponding velocity and position according to some implementations of the present disclosure.

FIG. 14 illustrates a flow chart of a method according to an implementation of the present disclosure.

FIG. 15 illustrates a schematic for adjusting deceleration profiles according to an implementation of the present disclosure.

FIG. 16 is a block diagram illustrating an example device.

### DETAILED DESCRIPTION

The following detailed description is made with reference to the figures. Example implementations are described to illustrate the technology disclosed, not to limit its scope, which is defined by the claims. Those of ordinary skill in the art will recognize a variety of equivalent variations on the description that follows.

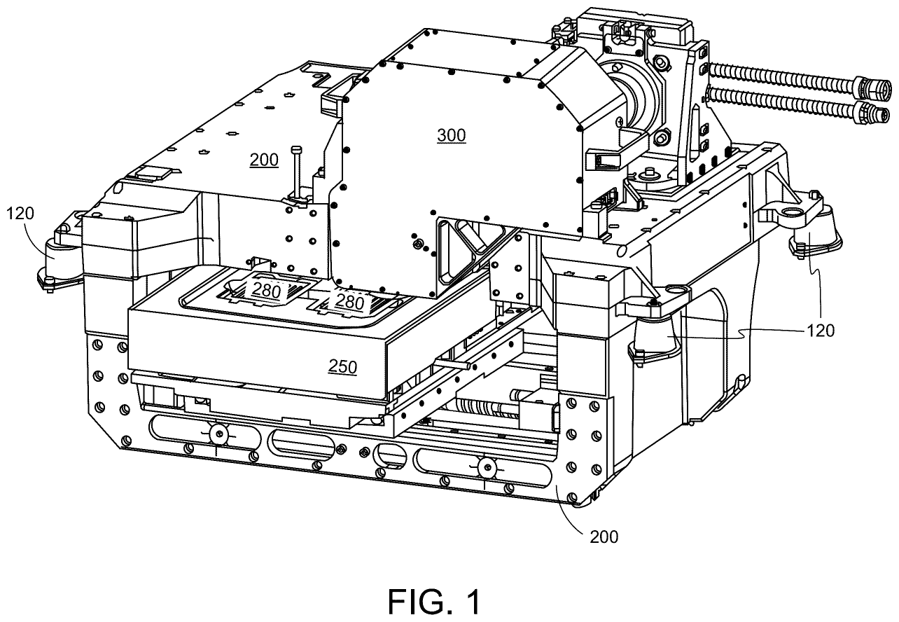

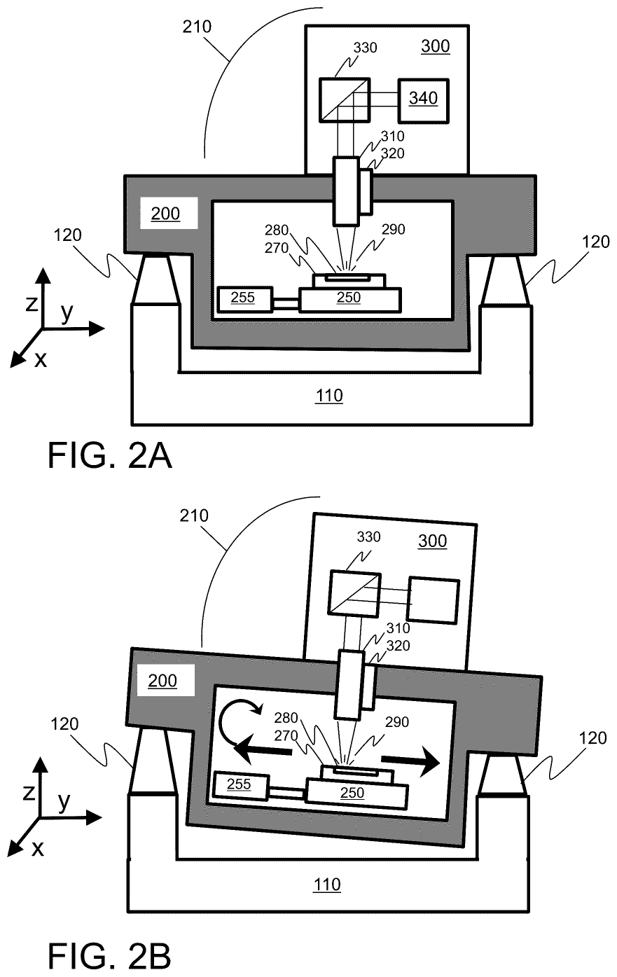

In the example of a fluorescence-based nucleic acid sequencing system, as illustrated in FIG. 1 and FIG. 2A, a chassis 110 may use a number of isolators 120 to support an isolated mass 200 comprising a detection system 210. This system 210 comprises a motion stage 250 moved within the x- and y-plane of the system using drivers 255, such as one for motion along an x-axis, a y-axis, and/or a z-axis.

The motion stage 250 may be designed with a mount 270 to hold samples containing an analyte, such as genetic material contained in one or more nucleic acid strands. The samples may be contained on or within a flow cell 280, such as one designed by ILLUMINA, Inc. The flow cell 280 may be a sample container that includes a patterned substrate or a non-patterned substrate. The patterned substrate may include depressions separated by interstitial regions, and surface chemistry positioned in the depressions. The depressions may be in the form of microwells or nanowells. A complementary reagent, such as a complementary nucleic acid or a reagent including other oligonucleotides with a fluorescent component, for example a fluorescent dye, may be flowed into the depressions of the flow cell 280 to bind or otherwise associate with the analyte of interest. The fluorescent component, such as a dye, can be illuminated with particularly selected light or radiation (not shown) to emit a fluorescent response that is indicative of the complementary reagent component with which it is associated. The emitted fluorescence 290 may be collected by an imaging system 300, comprising one or more objective lenses 310 that can be controlled by a focus control system 320. An optical system 330 relays the light collected onto one or more cameras 340, which converts the detected light into electronic signals for further computational processing.

Flow cell 280 may be mounted on the motion stage 250 to provide movement and alignment of the flow cell 280 relative to the objective lenses 310. The sample stage may have one or more actuators to allow it to move in any one or more of three dimensions. For example, in terms of the Cartesian coordinate system, actuators may be provided to allow the stage to move in the x, y, and/or z directions relative to the objective lenses 310. This may allow one or more sample locations on flow cell 280 to be positioned in optical alignment with objective lenses 310. Movement of motion stage 250 relative to objective lenses 310 may be achieved by moving the motion stage 250, the objective lenses 310, some other component of the imaging system, or any combination of the foregoing. Further implementations may also include moving the entire imaging system over a stationary sample. Alternatively, flow cell 280 may be fixed during imaging.

In some implementations, the imaging system may include one or more structures or components governing focus settings for the imaging system to view the optical target (e.g., fluorescent dye emissions from samples located on the flow cell 280) to be imaged. For example, the imaging system may include a focus (on the z-axis) component to control positioning of the optical system 330 relative to the motion stage 250 in the focus direction (which may be referred to as the z-axis, or z-direction). The focus component may be orthogonal to the x-y plane. The focus component may include one or more actuators physically coupled to the optical system 330, the motion stage 250, or both, to move flow cell 280 on the motion stage 250 relative to the optical system 330 (e.g., the objective lenses 310 or the optical system 330, or a component thereof, relative to the flow cell 280 on the motion stage 350) to provide proper focusing for the imaging operation. For example, the actuator may be physically coupled to the respective stage such as, for example, by mechanical, magnetic, fluidic or other attachment or contact directly or indirectly to or with the stage. The one or more actuators may be configured to move the stage in the z-direction while maintaining the sample stage in the same plane (e.g., maintaining a level or horizontal attitude, perpendicular to the optical axis). The one or more actuators may also be configured to tilt the stage. This may be done, for example, so that flow cell 280 may be leveled dynamically to account for any slope in its surfaces.

The actuators for controlling the motion stage 250 may comprise drivers 255 to move the flow cell 280 in a scanning pattern within one or more of the x-y-z dimensions of the system. For example, the motion stage 250 may be designed with drivers 255 to move the flow cell 280 in the x-y-z dimensions of the system. In some implementations, stepper motors may be used for the drivers 255, while in other implementations, magnetic linear motors may be used. In some implementations one or more axes may be driven by a stepper motor, while one or more other axes may be driven by a magnetic linear motor. For example, the x-axis may be driven by a stepper motor, while the y-axis may be driven by a linear motor. The z-axis may also be driven by a stepper motor or a linear motor. Other stage motion controls and control systems may be implemented, as will be commonly known to those skilled in the art.

As the motion stage 250 scans, rapid acceleration of motion in the direction of one of the axes, for example, the y-axis, can cause an equal and opposite reaction for the isolated mass 200. As the isolated mass 200 is constrained by the isolators 120 and not free to translate in the opposite y-axis direction, the energy instead may induce a rotation around the x-axis. This is illustrated in FIG. 2B. This rotation around the x-axis also can have a motion component in the z-direction, and so the attached imaging system and camera may also experience motion in the z-direction. Similarly, the rapid acceleration of motion in the z-direction can cause a reaction or rotation around the x-axis and/or y-axis, resulting in the attached imaging system and camera experiencing motion in the x-direction and/or y-direction.

The scanning pattern may scan in any sequence or direction. In some implementations, the scanning pattern can proceed in a sequential pattern that may correspond to a layout of features, such as nanowells, formed in the flow cell 280 to contain the sample. An imaging system may be positioned above the motion stage 250 to collect the fluorescence data from the flow cell 280. In other implementations, the imaging system may be positioned below the motion stage 250. The imaging system may be fixed or stationary relative to the motion stage 250, but may have its own servo controls to adjust focus along the z-dimension of the system to ensure accurate data collection from the sample within the flow cell 280. In other implementations, the imaging system may be moveable relative to the motion stage 250. In particular embodiments, the sample sequencing system is or includes a scanning time-delay integration (TDI) system. Furthermore, the sequencing system may include “line scanning” one or more samples such that a linear focal region of light is scanned across the sample(s), as described in U.S. Pat. No. 7,329,860, which is incorporated herein by reference. The sequencing system may also move a point focal region of light in a raster pattern across the sample(s). Alternatively, one or more regions of the sample(s) may be illuminated at one time in a “step and shoot” manner. In some embodiments, the sequencing systems may include a dynamic auto focusing operation as disclosed in U.S. Pat. No. 9,404,737, which is incorporated herein by reference. A dynamic auto focusing operation may analyze a focus setting at each displacement of the flow cell 280 during scanning/step-and-shoot and generate a focus score based on at least one of contrast, spot size, a signal-to-noise ratio, and/or a mean-square-error between pixel values for the at least one image being analyzed. Based on a focus score, dynamic auto focusing operation may affect a shift in the focal setting for a next scanning/step-and-shoot step, which may include modulating a z-position of the motion stage 250 with respect to the objective lenses 310 and/or the z-position of the objective lenses 310 with respect to the optical target (e.g., flow cell 280).

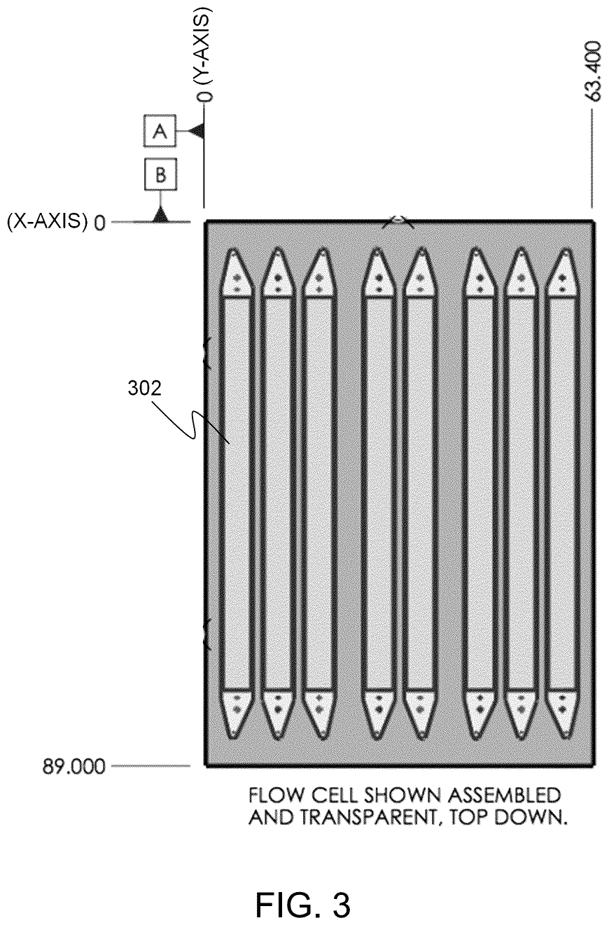

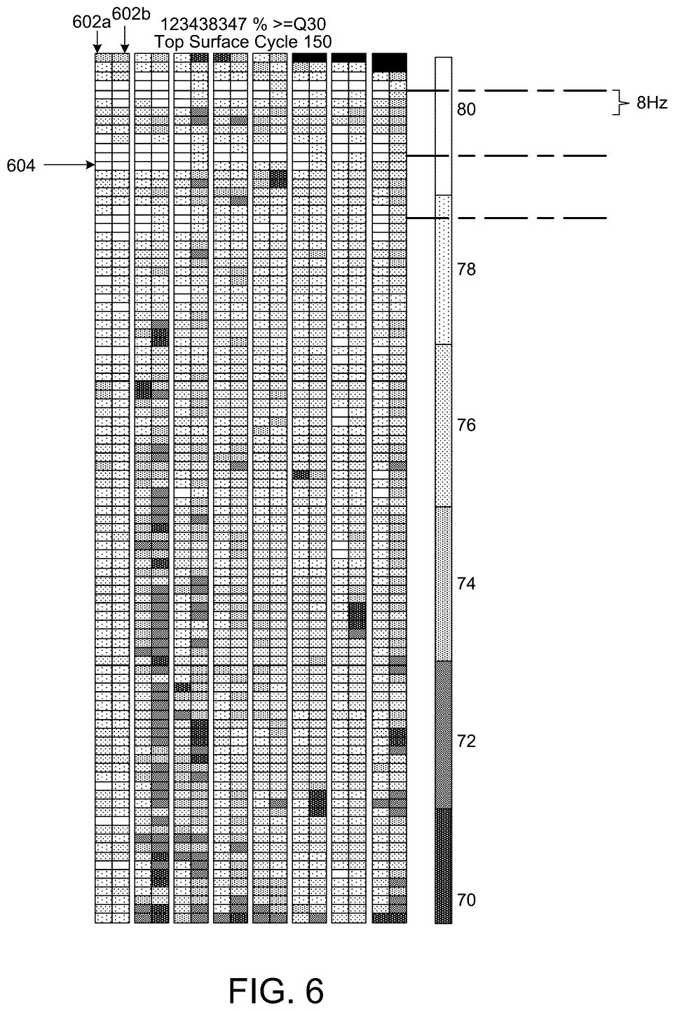

In some implementations, as described herein, the sample may be contained in the flow cell 280 in patterned nanowells that may be formed in one or more lanes. Each lane may comprise one or more linear swaths of patterned nanowells. In some implementations, the patterned nanowells may be in a hexagonal pattern, a rectilinear pattern, or any other repeating pattern. An illustration of an example of a flow cell 280 is shown in FIG. 3. The flow cell 280 may contain a number of lanes 302 that can be further subdivided into a number of linear swaths. FIG. 3 illustrates a flow cell with 8 lanes 302, but each of the lanes 302 can be subdivided into one or more linear swaths, such as two swaths 602a, 602b (the swaths being collectively referred to as swaths 602) for a total of the 16 linear swaths 602 shown in FIG. 6.

These swaths 602 are imaged by aligning the imaging system along the longitudinal axis of one swath 602a, then accelerating the motion stage 250 to move the sample flow cell 280 such that the swath 602a is positioned under and scanned by the imaging system until the end of the swath 602a has been reached. The motion stage 250 then decelerates and stops, and then changes position to align the next longitudinal axis of the next swath 602b for data collection. As described, once started, the motion along a swath is continuous, with images being collected while the stage is moving at a constant or near constant velocity. In some implementations, each swath 602 can be further subdivided into rectilinear tiles 604, such as those shown in FIG. 6, for further processing. This can continue until images for each of the swaths 602 have been collected for a first surface. If the flow cell 280 includes two or more surfaces to be imaged, the imaging system can be positioned to interrogate a second or subsequent surface and the foregoing process can be repeated for the second or subsequent surface.

For some systems (and, for convenience in notation, in this description) a direction parallel to the swath will be designated as the y-axis for the system.

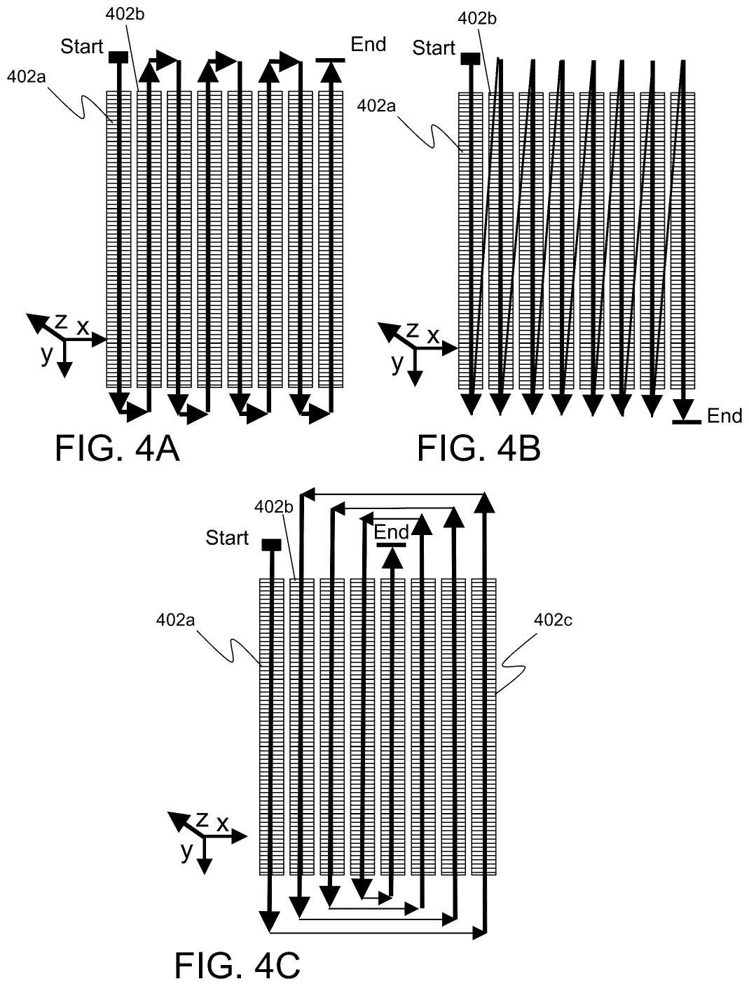

The stage motion for a series of parallel linear tracks as shown in the flow cell illustration of FIG. 3 may proceed in any number of patterns as may be known to those skilled in the art. FIGS. 4A-4C illustrate a number of possible scanning patterns available for imaging a flow cell. In FIG. 4A, a serpentine pattern is used, with the system moving in a positive y-direction for the first swath 402a, translating along the x-axis to the second swath 402b, and then moving in a negative y direction along the second swath 402b, and so on until each of the swaths are imaged. In FIG. 4B, a raster scan is used, with the system collecting images only when scanning in the positive y-direction along each of the first swath 402a, the second swath 402b, and so on until each of the swaths are imaged. The system may move back to the start of each swath before scanning in the positive y-direction. In FIG. 4C, a spiral pattern is used. As shown in FIG. 4C, the system may move in the positive y-direction along the first swath 402a. The system may translate along the x-axis to swath 402c, and move in the negative y-direction along the swath 402c. The system may translate along the x-axis in the opposite direction to swath 402b, and again move in the positive y-direction along the swath 402b. The system may continue operating in the spiral pattern until an end condition is met. Though FIG. 4C illustrates a system operating from the outermost swaths 402a, 402c and working inward, the system may also begin at one or more inner most swaths and work outward to the outermost swaths. Other scanning patterns may be known and used by those skilled in the art, depending on the design and configuration of the flow cells and sample material holders used, and the repeatability and reliability for the particular stage controls used for positive and negative scanning in x-, y-, and/or z-directions.

As the system moves the flow cell containing the sample, the imaging system may have z-axis servo controls that control the objective in the z-axis in response to servo control signals to ensure that the analyte of interest and the complementary reagent in the flow cell remains within the depth of focus of the imaging system. Although care may be taken to reduce the susceptibility of the z-axis control system to mechanical vibration, any mechanical system will have some mechanical frequencies at which the system will be resonant. Depending on the design and mass of the system, the induced motion may be small, or it can be quite large. Similarly, the control of the flow cell and/or components of the imaging system on the z-axis may result in mechanical vibration or resonance of components in the x- and/or y-directions.

In many circumstances, actuators may be utilized to perform x-axis, y-axis, and/or z-axis control on the system. As described herein, drivers may be used to move the stage in the x-, y-, and/or z-direction. Additionally, servo controls may be implemented via servo control signals as part of the z-axis control for the objective to allow focus to be maintained. When the amplitude and frequency of the resonant motion in a given direction is small, the servo can track the motion, and maintain focus. However, when the resonant motion amplitude is large, or the frequency too high, servo motors can have difficulty tracking and maintaining focus. In some implementations, if the depth of focus budget or tolerance is sufficiently small, maintaining tight focus even with small resonant motions may be desirable and the z-axis control may be insufficient alone.

As an example of one particular system, using a serpentine scanning pattern as was shown in FIG. 4A for a flow cell as was illustrated in FIG. 3, a scanning speed of 60 millimeters per second (mm/s) may be desirable to increase data collection along a swath in this system (for purposes of example, defined as being parallel to the y-axis of the system). The system aligns along the y-axis of the first swath 402a, and then can apply a single acceleration burst through the y-axis control (in this example, moving the stage using a magnetically controlled linear motor), and when approaching the end of the swath 402a, applies a single deceleration pulse to stop the scan.

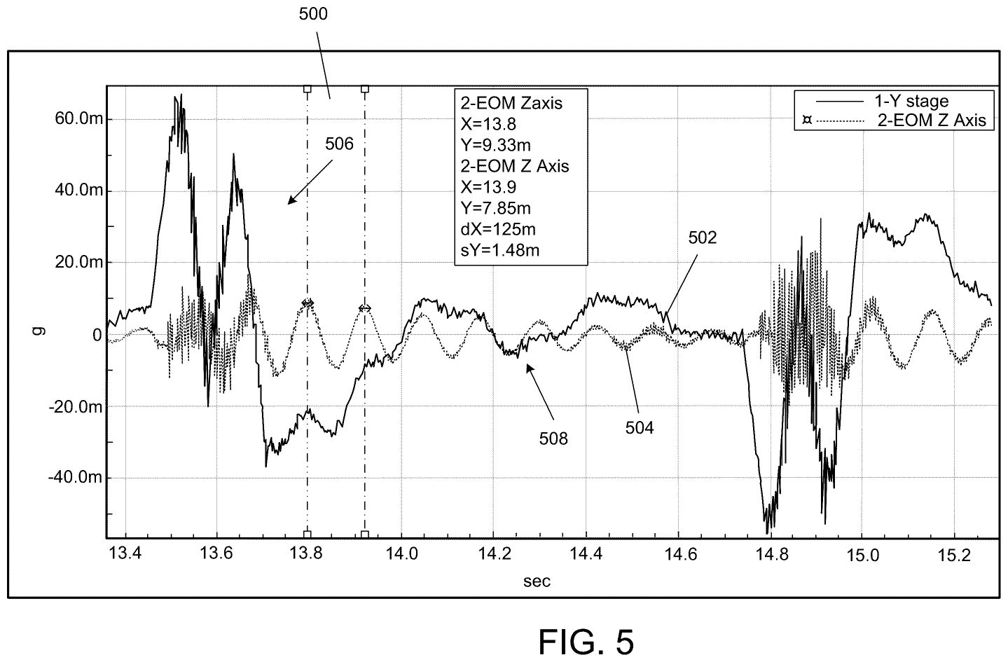

The impulse to accelerate to 60 mm/sec is applied in 0.125 seconds. However, this is coincidentally very close to being a period for a rocking resonance of the isolation mass at ˜8 Hz. The result of this acceleration is that z-axis motion is excited at ˜8 Hz (8.2 Hz for the system used in this particular example). This is illustrated in the graph 500 shown in FIG. 5, where the first trace 502 is y-direction acceleration (or deceleration) for the stage in the y-direction, and the second trace 504 is an indicator of motion for the objective lens along the z-axis.

The single acceleration impulse acceleration at the beginning of the scan, shown at 506 on the first trace 502, triggers mechanical vibration along the z-axis, illustrated at 508, that diminishes in amplitude but persists throughout the scan, only to be excited again by the deceleration at the end of the scan and again with acceleration at the beginning of the next scan.

The effect this has on collecting imaging data can be seen in FIG. 6. This image shows a composite image for a set of swaths 602 for a flow cell, measured using a raster scan configuration, as was illustrated in FIG. 4B, but for a flow cell with 16 swaths 602, arranged in pairs. As shown in FIG. 6, a “ringing” for the focus at ˜8 Hz is shown near the beginning of each scan (at the top of the image), after the initial single acceleration pulse. The “ringing” can be seen by the fluctuation in movement from ˜70 mm/s to ˜80 mm/s. The “ringing” effect damps down as the scan progresses, but the consistency and quality of the data collected with such artifacts is reduced. Though examples are provided for acceleration and/or deceleration for the stage in the y-direction, and an indicator of motion for the objective lens along the z-axis, it will be understood that movement of the stage and/or components of the imaging system along the z-axis may cause similar effects along the x-axis and/or y-axis.

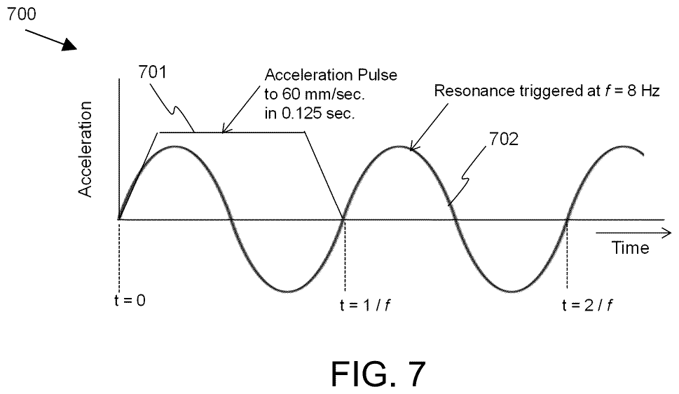

FIG. 7 shows a graph 700 that schematically illustrates the acceleration of the stage in the y-dimension triggering a sine wave response in the z-axis direction. The response may be more pronounced if the initial acceleration impulse has a time period coincident with the resonance frequency, as is the case for an impulse to accelerate applied in ˜0.125 seconds for a system with a rocking resonance of 8 Hz. As shown in the graph 700, the system may initiate a pulse 701 to accelerate the stage to 60 mm/second during the first 0.125 seconds of a scan, which may result in the mechanical resonance shown by the sine wave 702.

One way to address this, according to an implementation of the present disclosure is to perform input shaping to reduce the vibrations by controlled acceleration impulses at predefined times. The input shaping may be performed by dividing the acceleration of the x-y stage into structured acceleration impulses. This can allow the desired mechanical x-y acceleration to be achieved in approximately the same time, but can avoid exciting the mechanical resonance.

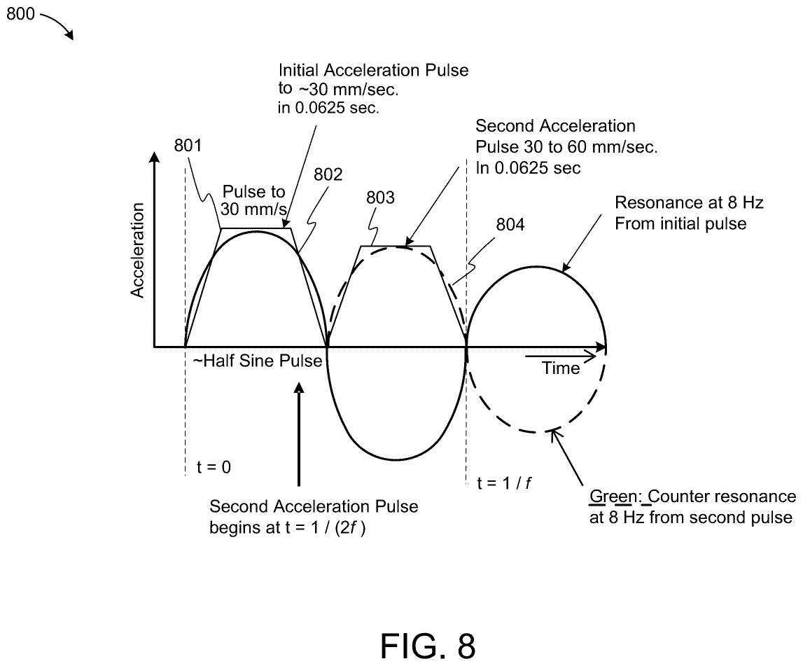

This is illustrated in the graph 800 of FIG. 8. To implement embodiments according to the present disclosure, an initial acceleration impulse may be applied. This can, as shown in the graph 800 in FIG. 8, be a pulse 801 to accelerate the stage, for example, from 0 to 30 mm/sec applied over 0.0625 sec. As with any impulse applied to the mechanical system, vibrations at the resonance frequency 802 may be excited by the initial impulse 801. These vibrations are shown by the sine wave of the resonance frequency 802 in the graph 800 of FIG. 8.

However, following the initial acceleration impulse 801, if a second pulse 803 to accelerate the stage is applied starting at time t=1/(2/f), the half period of the resonance frequency 802, a second set of vibrations will be excited by the second impulse 803. These second vibrations will be 180° out of phase with the vibrations 802 triggered by the initial impulse 801, and these second vibrations may be shown as the counter-resonance frequency 804 in FIG. 8. If the amplitude of the counter-resonance frequency 804 caused by the second pulse 803 is adjusted to be slightly smaller than the resonance frequency 802 caused by the initial impulse 801, to account for damping of the initial vibrations in the intervening time, the resonance frequency 802 of the mechanical vibration excited by the initial pulse 801 can be exactly cancelled by the counter-resonance frequency 804 of the counter-vibration excited by the second pulse 803, and no net vibration may occur along the z-axis.

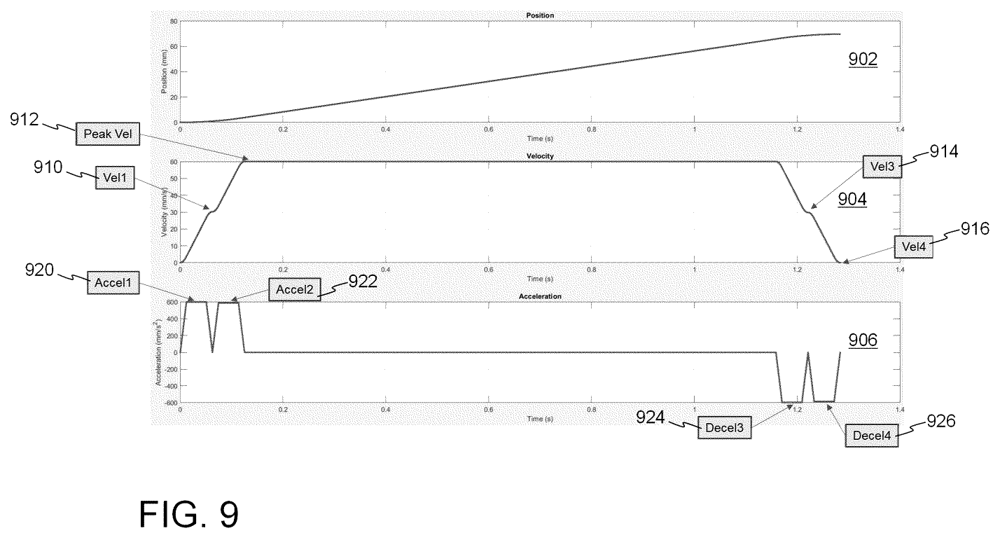

FIG. 9 illustrates example graphs 902, 904, 906 of an acceleration plan for scanning a swath of a flow cell using segmented acceleration. The plot of the graph 902 shows the position of the stage, in millimeters, moving as a function of time. The plot of the graph 902 shows a smooth linear scan when the system is scanning different swaths of a flow cell. The plot of the graph 906 shows the applied acceleration, in minutes per second, of the stage with two impulses 920, 922 for acceleration at the beginning of the scan and two impulses 924, 926 for deceleration at the end of the scan. The plot of the graph 904 illustrates the velocity of the flow cell, showing the rise to peak velocity 912 and a constant velocity scan. The plot in graph 904 shows the changes 910, 912 in velocity at respective impulses 920, 922 for acceleration at the beginning of the scan, as well as the changes 914, 916 at respective impulses 920, 922 for deceleration at the end of the scan

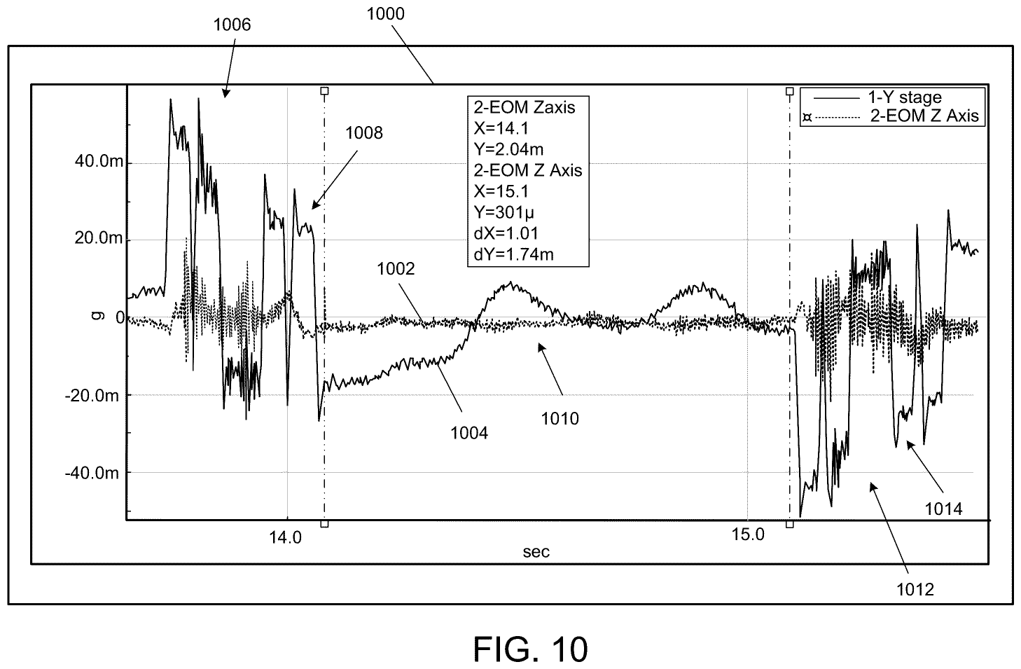

The results of providing such structured acceleration are shown in the graph 1000 of FIG. 10. Data was collected using the same system used for the data shown in FIG. 5, and the stage is again accelerated on the y-axis, in meters over time, as illustrated by the plot 1002, to a scan speed of 60 mm/sec over a time interval of 0.125 sec. But now, the stage is accelerated on the y-axis using two acceleration impulses illustrated at 1002 and 1004, a first motion illustrated at 1006 to accelerate to a speed of 30 mm/sec, and then, after a brief pause, a second impulse illustrated at 1008 having a slightly smaller amplitude to accelerate to a final speed of 60 mm/sec. The same final scan speed is achieved in the same amount of time as with a single impulse, but the resonances from the two acceleration impulses illustrated at 1002 and 1004 will cancel, and the motion along the z-axis, illustrated by the plot 1004, shows little to no motion at 8 Hz or between acceleration/deceleration of each scan, as illustrated at 1010.

In this example, as also illustrated in FIGS. 9 and 10, the deceleration at the end of the scan is also divided into two impulses (shown at 924, 926 of FIG. 9 and at 1012, 1014 of FIG. 10), achieving the goal of reducing the excitation of the z-axis resonance without significantly increasing the time for scanning in the x-y plane. Once again, the second impulse is applied at a time 1/(2f) after the beginning of the initial deceleration pulse, to allow vibrations triggered by the first deceleration pulse to be cancelled by counter-vibrations that are 180° out of phase triggered by the second pulse.

Although the examples illustrated above show dividing the acceleration impulse into two segments, any number of acceleration segments could be used, as long as the frequency content of the acceleration has a reduced overlap with the mechanical resonances of the z-axis system. Additionally, though examples are provided for acceleration and/or deceleration for the stage in the y-direction, and motion for components along the z-axis, it will be understood that movement of the stage and/or components of the imaging system along the z-axis may cause similar effects along the x-axis and/or y-axis.

### Segmented Acceleration

The technology disclosed can be practiced as a method, a system, or article of manufacture. One or more features of an implementation described herein can be combined with other implementations.

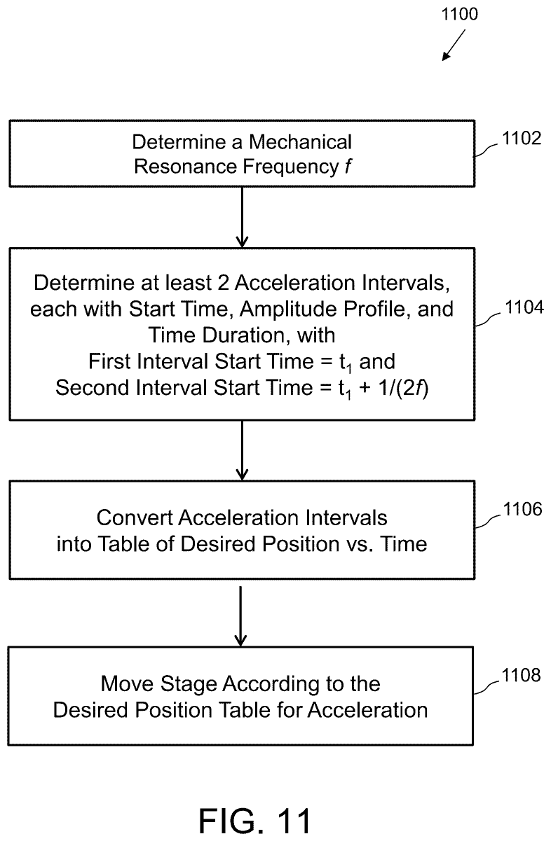

Methods, systems, and articles of manufacture are described to achieve input shaping by segmented acceleration for a stage in an imaging apparatus. The segmented acceleration for the stage in can be carried out as illustrated in the flow chart of FIG. 11 showing the example procedure 1100. One or more portions of the procedure 1100 may be performed by one or more devices described herein. For example, one or more portions of the procedure 1100 may be performed by one or more sequencing devices or other imaging devices. One or more portions of the procedure 1100 may be stored in memory as computer-readable or machine-readable instructions that may be executed by a processor of the one or more devices. Though the procedure 1100 may be provided in a given sequence of steps, the one or more steps may be performed in another sequence or order, and/or one or more steps may be added or removed.

In the first step 1102, at least one mechanical resonance frequency f is determined. The resonance frequency or frequencies may be determined using formal mechanical analysis tools, described in more detail below, or through observation of experimental results, as was shown in FIGS. 5 and 6, or may be simply known in advance from previous experience. In some implementations, one or more image analysis characteristics, such as data quality or other characteristics, can be measured or detected. If the image analysis characteristic falls below or exceeds a predetermined threshold value, then the system can perform an analysis to detect whether a mechanical frequency f is affecting the change in the image analysis characteristic and the value of the mechanical frequency f For example, a Fast Fourier Transform analysis may be performed on the image analysis characteristics and/or a motion profile of an x-stage, y-stage, and/or z-stage of the system to detect the mechanical frequency f.

The disturbance frequency may be determined/characterized/measured using an accelerometer. The disturbance frequency may be determined/characterized/measured by analyzing the z-stage position error signal or the current signal and identify the disturbance frequency and decay rate. This may then be feed into the design of the input shaping motion profiles. The benefit of this may be that over time as instrument degradation occurs, the disturbance frequency/amplitude/decay rate may change, so adjusting/updating the input shaping motion profiles may result in maintaining the reduction ratio of the vibration amplitude to the same original value at the first instance of design.

At 1104, at least two acceleration intervals for the stage and/or the components of the imaging system are determined, with each acceleration interval having a start time, an acceleration amplitude profile, and a time duration. The amplitude profile may indicate an amplitude of respective acceleration intervals over at least a portion of the time duration. Acceleration intervals are designated in pairs, one for each frequency identified in the previous step, and for each first acceleration interval starting at t=t₁, the second acceleration interval will begin at approximately t₂=t₁+1/(2/f). By approximately, it is meant that t₂ is generally within ±10% of t₁+1/(2/f), although if the vibration is small or the damping large, some success may be even achieved in systems where t₂ is ±30% of t₁+1/(2/f).

The length of time for the pause between the acceleration intervals may also be set in this step, although in some implementations, the time between pulses may be zero, as the second pulse begins immediately at the end of the first acceleration interval.

At 1106, the acceleration intervals are converted into commands for the stage. In some implementations, the acceleration intervals are converted into a table of desired positions as a function of time. The acceleration intervals may be automatically determined by a device in response to receiving the acceleration intervals and the length of time for the pause. In another example, the acceleration intervals may be received at a device via configuration information for configuring the acceleration of the stage.

At 1108, the stage and/or the components of the imaging system is accelerated according to the at least two acceleration intervals.

### Determination of Resonance Frequencies

Mechanical resonance frequencies f₁ . . . fₙ can be determined a number of ways.

Solid modeling programs for designing large, complex pieces of equipment, such as SOLIDWORKS by Dassault Systems, can take as input the dimensions, compositions, and densities of various connected components and make computer predictions of various vibrational modes that may result. These modeling programs may be implemented on one or more computing devices or other devices described herein, such as sequencing devices or imaging devices, as described herein. As solid modeling systems are often used in the design of mechanical imaging systems, frequency analysis may already exist for some systems. The resonance frequencies from such an analysis can be used at least as an initial estimate of mechanical resonances for an imaging system with a moving stage.

The resonance frequencies can also be measured experimentally. Placing an energetic impulse acceleration into the system provides an approximation to a delta function mechanical input, which may contain each of the frequency components. Measuring which mechanical vibrations result in “ringing” from such an impulse input using accelerometers and the like can provide an indication of the resonant mechanical frequencies. The “ringing” may be determined from a threshold level of resonance within a threshold period of time.

As was illustrated in FIGS. 5, 6, and 10, experience with and/or measurements of the mechanical behavior of the system while in use can also yield measurements indicating resonant frequencies. In a system having servo controls to adjust motion along the z-axis to maintain focus, a read out of the servo control error signals can provide an indication of the mechanical vibrations the system is attempting to correct. In a system having drivers or other actuators to adjust motion along the x-axis, y-axis, or z-axis, a read out of the driver or actuator error signals can provide an indication of the mechanical vibrations the system is attempting to correct. Artifacts in measured data, such as is shown in FIG. 6, can also provide an indication of mechanical resonance frequencies.

### Determination of Acceleration Intervals

Once one or more resonance frequencies f₁ . . . fₙ are known, acceleration intervals can be determined to avoid excitation of those multiple frequencies.

In general, acceleration intervals may be determined in pairs, one for each frequency, wherein if the first acceleration interval starting at time t₁ begins to excite a resonance vibration at frequency f₁, the second acceleration interval will be timed to begin at approximately t₂=t₁+1/(2f₁), which excites a resonance vibration 180° out of phase with the initial resonance vibration. The two excited resonances may cancel each other, resulting in no net vibration or a net vibration under a certain threshold.

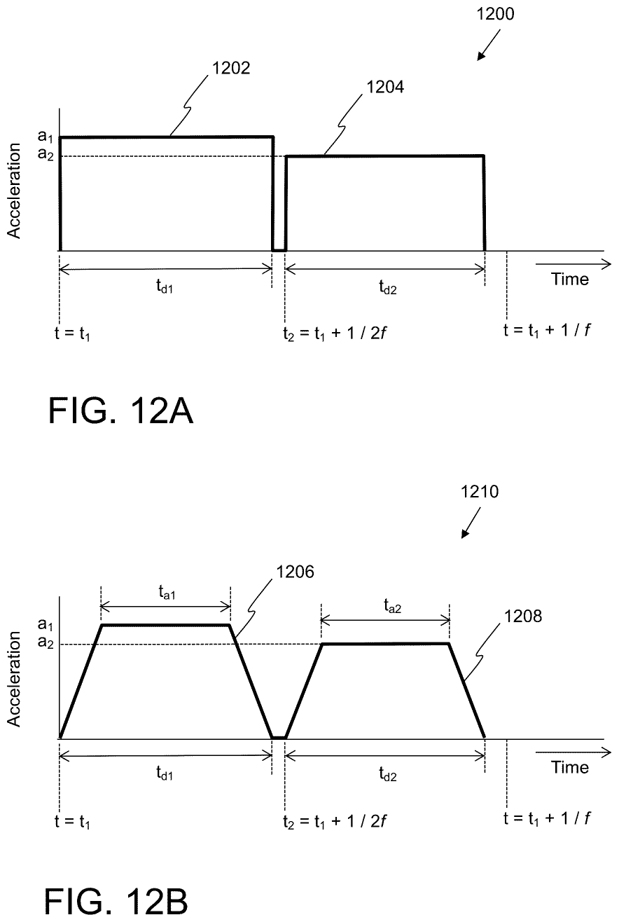

In some implementations, an amplitude profile may be implemented as illustrated in the graph 1200 of FIG. 12A. For example, there may be one resonant frequency of interest, and acceleration of the stage may occur using two initial acceleration intervals 1202, 1204 at respective amplitudes a1, a2 to initiate motion. In some implementations, the amplitude profiles of the acceleration intervals 1202, 1204 may follow a constant profile—no acceleration until time t₁, constant acceleration over interval 1202 at some value a₁ for some time duration t_{d1}, then zero acceleration at the end of the first interval, until, at time t₂=t₁+1/(2f₁), the acceleration again is set over interval 1204 to a constant value a₂ for a second time duration t_{d2}. After which the acceleration may be set again to zero.

The selection of the amplitude a₂ relative to the value of a₁ may be set in any number of ways. In some implementations, a₁=a₂. In some implementations, a₁>a₂, with a₂ selected based on the reduction or decay in vibrational amplitude due to damping seen in measured observations. The damping or decay factor for the resonance frequency that is observed in data may be as shown in FIG. 5 and can be used to set the value of as relative to a₁.

More complex amplitude profiles may also be selected. For example, as shown in the graph 1210 of FIG. 12B, I acceleration may be initiated at a time t₁ and steadily increased over acceleration interval 1206 until a predetermined value of acceleration a₁ is reached, and then maintained at that value of acceleration for a time tₐ₁. At the end of this time, acceleration may be decreased steadily at the end of the interval 1206 instead of being abruptly ended. Likewise, a second acceleration interval 1208 may be initiated at a time t₂=t₁+1/(2f₁), and steadily increased until a predetermined value of acceleration a₂ is reached, and then maintained at that value of acceleration for a time tₐ₂. At the end of this time, acceleration may be decreased steadily at the end of the interval 1208 instead of being abruptly ended.

In practice, most mechanical systems cannot instantly turn on acceleration as shown in the graph 1200 of FIG. 12A, and so some profile similar to the profile illustrated in the graph 1210 of FIG. 12B may be generally implemented in practice. More complex functional descriptions for acceleration profiles may also be used as they may be found experimentally to be less likely to excite various mechanical resonances.

Likewise, in some implementations, t_{d1}=t_{d2}, and for some implementations, t_{d1}≠t_{d2}. In some implementations, t_{d1}<1/(2f) and t_{d2}<1/(2f). And similarly, in some implementations, t_{d1}=t_{d2}, but for some implementations, t_{d1}≠t_{d2}.

The two illustrations of FIG. 12A and 12B both show possible implementations in which there is a gap between the end of the first acceleration interval and the beginning of the second acceleration interval. In practice, the first acceleration interval may be selected to end at t₂=t₁+1/(2f₁), the starting point of the second acceleration interval, as was illustrated in the example of FIG. 9. In this case, t_{d1}=−t₂−t₁.

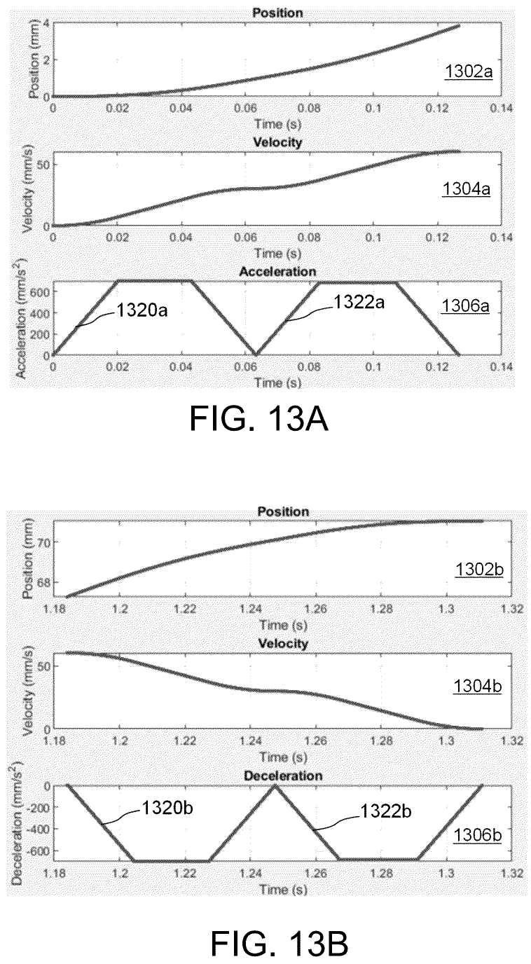

FIG. 13A shows graphical illustrations 1302a, 1304a, 1306a in more detail of a pair of acceleration intervals 1320a, 1322a and their corresponding plots of velocity and position. The plot of the graph 1302a shows the position of the stage, in millimeters, moving as a function of time. The plot of the graph 1302a shows a smooth linear scan when the system is scanning different swaths of a flow cell. The plot of the graph 1306a shows the applied acceleration, in minutes per second, of the stage with two impulses 1320a, 1322a for acceleration at the beginning of the scan. The plot of the graph 1304a illustrates the velocity of the flow cell over time. The plot in graph 1304a shows the change in velocity over respective impulses 1320a, 1322a for acceleration at the beginning of the scan

FIG. 13B shows similar graphical illustrations 1302b, 1304b, 1306b of a pair of deceleration intervals 1320b, 1322b and their corresponding plots of velocity and position. The plot of the graph 1302b shows the position of the stage, in millimeters, moving as a function of time. The plot of the graph 1306b shows the applied acceleration, in minutes per second, of the stage with two impulses 1320b, 1322b for deceleration at the end of the scan. The plot of the graph 1304b illustrates the velocity of the flow cell over time. The plot in graph 130ba shows the change in velocity over respective impulses 1320b, 1322b for deceleration at the end of the scan.

The position data, such as that shown in these illustrations, may be converted into a table of position vs. time, and provided as input to the actuator (e.g., motor) driving the y-axis of the stage using a standard programming interface provided. Similar position data may be converted a into a table of position vs. time, and provided as input for the actuator driving the x-axis or z-axis of the stage.

In some implementations, deceleration may occur after the scan is concluded, allowing a settling time for any vibrations caused by deceleration before proceeding to the next scan, if any. This may in some circumstances be a simpler approach, as no imaging data may be collected after the scan of the swath is completed, and so additional ringing and vibration may not affect data collection.

However, in some implementations, waiting for any ringing caused by deceleration to die out may require additional time, and data collection can be more efficient if deceleration also occurs using segmented deceleration intervals. These deceleration intervals may also be timed so that, if the first interval begins at time t₃, the second interval begins at t₄=t₃+1/(2f₁), to again excite a counter-resonance at 180° out of phase to the first deceleration interval, canceling any vibration caused by the first deceleration interval, as was shown in FIG. 13B, for example.

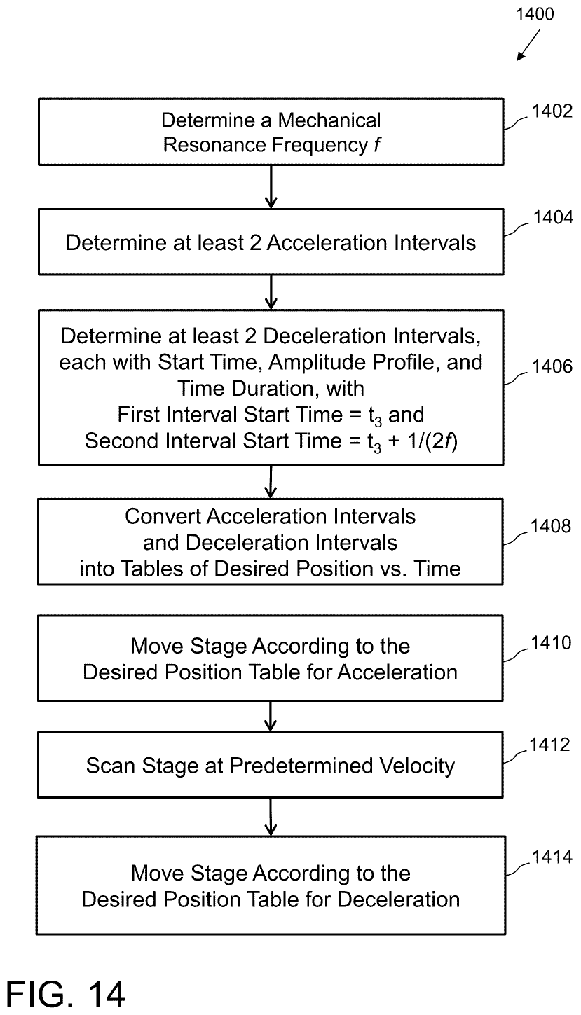

A modified process presenting this is illustrated in the flow chart of FIG. 14 showing the example procedure 1400. One or more portions of the procedure 1400 may be performed by one or more devices described herein. For example, one or more portions of the procedure 1400 may be performed by one or more sequencing devices or other imaging devices. One or more portions of the procedure 1400 may be stored in memory as computer-readable or machine-readable instructions that may be executed by a processor of the one or more devices. Though the procedure 1400 may be provided in a given sequence of steps, the one or more steps may be performed in another sequence or order, and/or one or more steps may be added or removed.

As shown in FIG. 14, a mechanical resonance frequency f may be determined at 1402. At 1404, at least two acceleration intervals may be determined. The step of determining any resonant frequencies at 1402 and the step of determining the two acceleration intervals at 1404 may be performed as similarly described with reference to steps 1102 and 1104, respectively, of FIG. 11. However, following (or concurrent with) the determination of the acceleration intervals, deceleration intervals may also be determined at 1406. Each deceleration interval may include a start time, amplitude profile, and/or a time duration. A first interval start time may be equal to t₃. A second interval start time may be equal to t₃+1/(2f).

At 1408, the acceleration and deceleration intervals may be converted into commands for the stage. In some implementations, the acceleration intervals may be converted into a table of desired positions as a function of time.

At 1410, the stage may be accelerated according to the table for position vs. time calculated from the at least two acceleration intervals. The acceleration intervals may be calculated at the device or received at a device via configuration information for configuring the acceleration of the stage.

After acceleration and reaching a predetermined scan velocity, at 1412 the scan of the swath may be carried out and data may be collected by the imaging system.

After the scan has reached its endpoint, at 1414 the stage may be decelerated according to the table for position vs. time calculated from the at least two deceleration intervals. The deceleration intervals may be calculated at the device or received at a device via configuration information for configuring the deceleration of the stage.

As with the description above for acceleration profiles, deceleration profiles may also follow a number of forms in various implementations, sometime of equal values, and sometimes with different values for deceleration for the two intervals, selected to allow cancellation of the damped vibration triggered by the initial deceleration pulse.

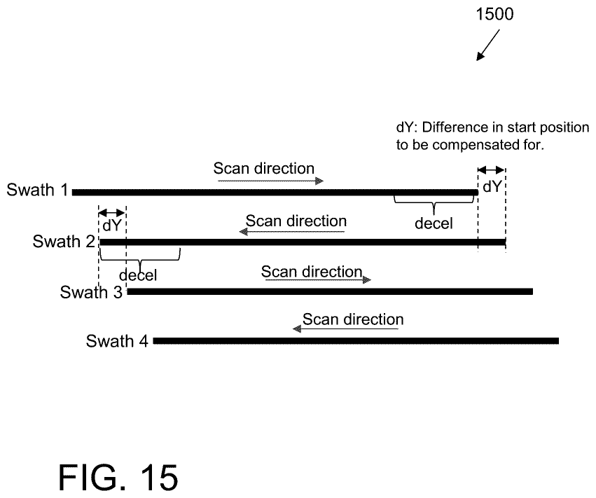

Deceleration can present particular problems when the alignment of the swaths of a flow cell is not perfectly parallel to the scanning axis, as may occur if the flow cell is at a slight angle. In this situation, the ends of the swaths may be slightly offset from each other, as is illustrated in the graph 1500 of FIG. 15. Programming the deceleration of the stage as if the swaths were aligned in parallel would mean there is an offset dY at the end of the motion that may be corrected to align with the next swath. This can take additional time, increasing the total scan speed.

When programming deceleration intervals, if this offset dY is known, compensation for this offset can be programmed into the table of position vs. time generated by the deceleration intervals. If there is a known dY to be added to the end of scanning a swath, as is illustrated in for Swath 1 in the graph 1500 of FIG. 15, the interval dY can be divided evenly over the deceleration intervals. For example, if there are 250 positions to be commanded in the deceleration intervals, an additional position of dY/250 can be added for each position in the deceleration interval, allowing the deceleration scan to end exactly aligned with the y-position of the next swath without an additional motion step being required.

Likewise, for deceleration in the opposite direction, dY/250 can be subtracted for each position in the deceleration interval, ensuring that the scan stops early, at the y-position to begin the scan of the next swath.

Although there may less perfect cancellation of any resonant vibrations that may be excited with the additional translation segments, no data is being collected in this part of the scan, and so some additional vibration can be tolerated in a tradeoff with the more efficient positioning alignment in preparation for the next swath.

### Moving a Stage According to the Acceleration Intervals

Once the acceleration profile has been determined, motion commands to direct the motion of the stage according to the acceleration profile can be generated.

In some genetic sequencing systems, the control of the stage along the direction of the channels in the flow cell (generally called the y-dimension) is carried out using a magnetic linear motor. The control of the stage in the x-dimension and/or z-dimension may similarly be carried out using a magnetic linear motor. Linear motors may be implemented because magnetic drives may operate with reduced backlash and friction, and offer better accuracy and repeatability for position control.

Programming software for such linear motors may be provided for the commercial linear motor units, and programming interfaces that allow specification of position as a function of time are common. The desired acceleration intervals and deceleration intervals, once determined, may be entered using a standard programming interface.

For some nucleic acid sequencing systems, the x-axis, y-axis, and/or z-axis motion may be controlled by magnetic linear motors such as a Parker 110-2N-NC-WD3P-8 linear motor. For such a system, a motion controller such as the ECMsa by ACS Motion Control may be used. Such controllers come with a standard interface protocol, which can include table inputs for position as a function of time, as may be calculated in the methods described above.

Conversion of acceleration (or deceleration) intervals, once derived, into position tables that govern motion commands can be a fairly straightforward calculation. Table I below presents the computation formulas for one approach to this conversion. Other formula conversion methods using various mathematical tools, such as MatLab, may be known to those skilled in the art.

### Other Variations and Implementations

This section expands on and can be combined with the summary and on the detailed descriptions provided above. Other implementations, variations, and equivalents may be apparent to those skilled in the art.

In some implementations, a resonant frequency may occur in the range of 1 to 250 Hz.

In some implementations, a resonant frequency may occur in the range of 7 to 10 Hz.

In some implementations, a resonant frequency may occur between 3 and 15 Hz.

In some implementations, multiple resonant frequencies may occur that are not harmonics of each other.

In some implementations, resonant frequencies may occur at 3.1 Hz, 8.2 Hz, and 13 Hz.

TABLE I
Example of formulas used to calculate position s and velocity v
for a given acceleration profile a.

${t}_{ramp} = \frac{\begin{matrix}{a}_{peak} - \\ {a}_{init}\end{matrix}}{j} , {t}_{const} = {t}_{pulse} - 2 * {t}_{ramp} , {v}_{max} = ( {t}_{const} * {a}_{peak} ) + 2 * v ( {t}_{ramp} )$
$a = \{ \begin{matrix}\begin{matrix}j * t + {a}_{init} , t < {t}_{ramp} \\ {a}_{peak} , {t}_{ramp} < t < {t}_{const}\end{matrix} \\ - j * t + a ( {t}_{const} ) , {t}_{const} < t < {t}_{const} + {t}_{ramp}\end{matrix}$
$v = \{ \begin{matrix}\begin{matrix}\frac{j}{2} * {t}^{2} + {a}_{init} * t + {v}_{init} , t < {t}_{ramp} \\ {a}_{peak} * t + v ( {t}_{ramp} ) , {t}_{ramp} < t < {t}_{const}\end{matrix} \\ \frac{- j}{2} * {t}^{2} + a ( {t}_{const} ) * t + v ( {t}_{const} ) , {t}_{const} < t < {t}_{const} + {t}_{ramp}\end{matrix}$
$s = \{ \begin{matrix}\begin{matrix}\frac{j}{6} * {t}^{3} + \frac{{a}_{init}}{2} * {t}^{2} + {v}_{init} * t + {s}_{init} , t < {t}_{ramp} \\ \frac{{a}_{peak}}{2} * {t}^{2} + v ( {t}_{ramp} ) * t + s ( {t}_{ramp} ) , {t}_{ramp} < t < {t}_{const}\end{matrix} \\ \frac{- j}{6} * {t}^{3} + \frac{a ( {t}_{const} )}{2} * t + v ( {t}_{const} ) * t + s ( {t}_{const} ) , {t}_{const} < t < {t}_{const} + {t}_{ramp}\end{matrix}$

In some implementations, values for parameters used to specify the acceleration intervals may be different from those that are used to define deceleration intervals, even within the same scan.

In some implementations, two acceleration intervals may overlap, with one being longer than a time duration of 1/(2f) seconds.

In some implementations, scans in a positive direction (e.g., x, y, or z-direction) may use different values for parameters for acceleration and deceleration intervals than are used for scans in a negative direction (e.g., x, y, or z-direction).

In some implementations, mechanisms that provide indications of resonant frequencies, such as the objective servo controller or other on-board accelerometers, may be monitored during scanning, and analyzed in real time on the fly for vibrational frequency components. Modifications to the acceleration and deceleration intervals may be made while scanning a given swath, or for subsequent swaths to compensate for vibrations detected while measuring a previous swath.

In some implementations, mechanisms that provide indications of resonant frequencies, such as the objective servo controller or other on-board accelerometers, may be monitored over longer periods of time, and modifications to the acceleration and deceleration intervals may be made to adapt to changes in the resonant frequency as the system ages.

In some implementations, mechanisms that provide indications of resonant frequencies, such as the objective servo controller or other on-board accelerometers, may be monitored over longer periods of time, and modifications to the acceleration and deceleration intervals may be made to adapt to changes in the resonant frequency as the system encounters different environmental conditions.

The method implementations disclosed optionally include one or more of the features described above. Method can also include features described in connection with methods disclosed. In the interest of conciseness, alternative combinations of system features are not individually enumerated. Features applicable to systems, methods, and articles of manufacture are not repeated for each statutory class set of base features. The reader will understand how features identified in this section can readily be combined with base features in other statutory classes.

A system implementation of the technology disclosed includes one or more processors coupled to memory. The memory is loaded with computer instructions to move a component, such as a stage, of an imaging apparatus having at least one mechanical resonance with frequency f Hz and time period 1/f seconds using an even plurality of acceleration intervals, each acceleration interval having a starting time, an amplitude profile, and a time duration; wherein, among the even plurality of acceleration intervals, for each first acceleration interval, there is a second acceleration interval with a starting time 1/(2f) seconds after the starting time of the first acceleration interval.

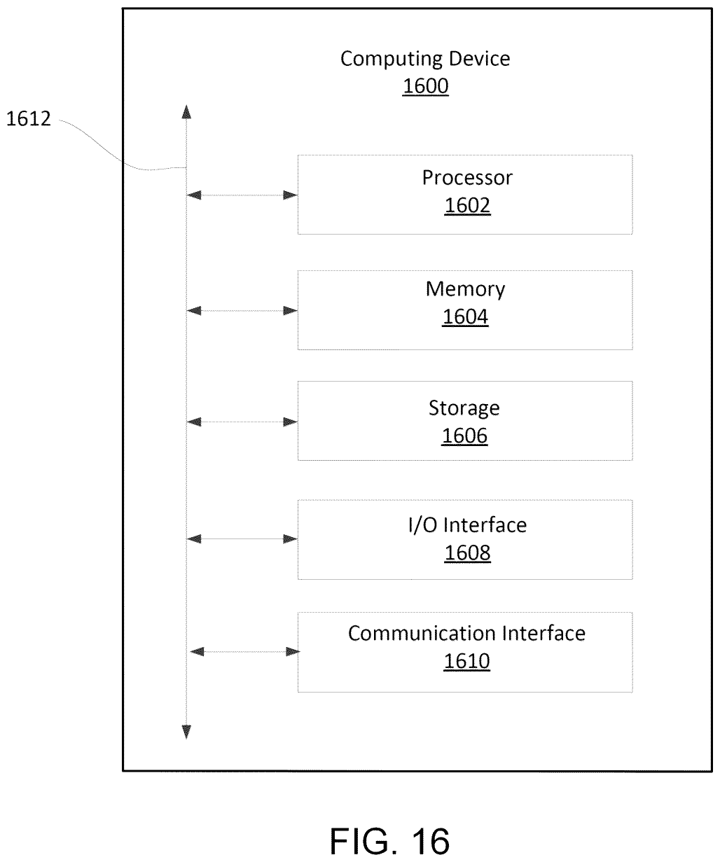

FIG. 16 is a block diagram illustrating an example device 1600. One or more devices, such as the device 1600, may implement one or more features for performing as described herein. For example, the device 1600 may comprise one or more of a sequencing device, an imaging device, or another computing device. As shown by FIG. 16, the device 1600 may comprise a processor 1602, a memory 1604, a storage device 1606, an I/O interface 1608, and/or a communication interface 1610, which may be communicatively coupled by way of a communication infrastructure 1612. The device 1600 may include fewer or more components than those shown in FIG. 16. For example, the device 1600 may also, or alternatively, include one or more components of the imaging system 300 shown in FIGS. 1, 2A, and 2B.

The processor 1602 may include hardware for executing instructions, such as those making up a computer application or system. In examples, to execute instructions for operating as described herein, the processor 1602 may retrieve (or fetch) the instructions from an internal register, an internal cache, the memory 704, or the storage device 1606 and decode and execute the instructions. The memory 1604 may be a volatile or non-volatile memory used for storing data, metadata, computer-readable or machine-readable instructions, and/or programs for execution by the processor(s) for operating as described herein. The storage device 1606 may include storage, such as a hard disk, flash disk drive, or other digital storage device, for storing data or instructions for performing the methods described herein.

The I/O interface 1608 may allow a user to provide input to, receive output from, and/or otherwise transfer data to and receive data from the device 1600. The I/O interface 1608 may include a mouse, a keypad or a keyboard, a touch screen, a camera, an optical scanner, network interface, modem, other known I/O devices or a combination of such I/O interfaces. The I/O interface 1608 may include one or more devices for presenting output to a user, including, but not limited to, a graphics engine, a display (e.g., a display screen), one or more output drivers (e.g., display drivers), one or more audio speakers, and one or more audio drivers. The I/O interface 1608 may be configured to provide graphical data to a display for presentation to a user. The graphical data may be representative of one or more graphical user interfaces and/or any other graphical content.

The communication interface 1610 may include hardware, software, or both. In any event, the communication interface 1610 may provide one or more interfaces for communication (such as, for example, packet-based communication) between the device 1600 and one or more other computing devices and/or networks. The communication may be a wired or wireless communication. As an example, and not by way of limitation, the communication interface 1610 may include a network interface controller (NIC) or network adapter for communicating with an Ethernet or other wire-based network or a wireless NIC (WNIC) or wireless adapter for communicating with a wireless network, such as a WI-FI.

Additionally, the communication interface 1610 may facilitate communications with various types of wired or wireless networks. The communication interface 1610 may also facilitate communications using various communication protocols. The communication infrastructure 1612 may also include hardware, software, or both that couples components of the device 1600 to each other. For example, the communication interface 1610 may use one or more networks and/or protocols to enable a plurality of computing devices connected by a particular infrastructure to communicate with each other to perform one or more aspects of the processes described herein. To illustrate, the sequencing process may allow a plurality of devices (e.g., a client device, sequencing device, and server device(s)) to exchange information such as sequencing data and error notifications.

This system implementation and other systems disclosed optionally include one or more of the features described above. System can also include features described in connection with methods disclosed. In the interest of conciseness, alternative combinations of system features are not individually enumerated. Features applicable to systems, methods, and articles of manufacture are not repeated for each statutory class set of base features. The reader will understand how features identified in this section can readily be combined with base features in other statutory classes.

Other implementations may include a non-transitory computer readable storage medium storing instructions executable by a processor to perform the methods or the functions of the system described above.

Computer readable media (CRM) implementations of the technology disclosed include a non-transitory computer-readable storage medium or machine-readable storage medium impressed with computer program instructions, when executed on a processor, implement the methods described above. The instructions may be stored on one or more computer-readable storage media or machine-readable storage media installed on the same or different devices.

Each of the features discussed in this particular implementation section for the first system implementation apply equally to the CRM implementation. As indicated above, all the system features are not repeated here and should be considered repeated by reference.

It will be recognized that, while specific implementations may be presented, elements discussed in detail for some implementations may also be applied to others.

While specific materials, designs, configurations and fabrication steps have been set forth to describe several implementations herein, such descriptions are not intended to be limiting. Modifications and changes may be apparent to those skilled in the art.

What is claimed:

1. A method for controlling stage motion for an apparatus for imaging having at least one mechanical resonance with frequency f Hz and time period 1/f seconds, comprising:
moving a component of the apparatus using motion commands, wherein the component comprises a stage configured to hold an object to be imaged within a flow cell, and wherein the motion commands are derived from an even plurality of acceleration intervals, each acceleration interval having a starting time, an amplitude profile, and a time duration, wherein the amplitude profile indicates an amplitude of the respective acceleration interval over at least a portion of the time duration;
wherein, among the even plurality of acceleration intervals, for each first acceleration interval, there is a second acceleration interval with a starting time approximately 1/(2f) seconds after the starting time of the first acceleration interval.

2. The method of claim 1, wherein:
the first acceleration interval excites a first vibration, and the second acceleration interval excites a second vibration, and the second vibration is approximately 180 degrees out of phase with the first vibration.

3. The method of claims 1 and 2, wherein
approximately is defined as a range of ±30%.

4. The method of claims 1 and 2, wherein
approximately is defined as a range of ±10%.

5. The method of claim 1, further comprising:
moving the component comprises motion within an x-y plane; and
wherein the mechanical resonance affects structures governing focus settings for an imaging system positioned to view the object to be imaged.

6. The method of claim 5, wherein:
stage motion occurs within the x-y plane, and the structures governing focus settings control the focus of an objective lens aligned along a z-axis orthogonal to the x-y-plane.

7. The method of claim 5, additionally comprising:
measuring indicators for mechanical motion of the structures governing focus settings while the component is moving; and
determining the amplitude profiles and time durations of at least some of the acceleration intervals based at least in part on the measured indicators.

8. The method of claim 7, wherein
the indicators comprise servo control signals.

9. The method of claim 7, wherein:
the indicators are used to determine the mechanical resonance frequency f in Hertz.

10. The method of claim 7, wherein:
the indicators are used to determine a decay of vibration at the mechanical resonance frequency f Hz, and
the determined decay of vibration is used to set one or more amplitude profiles for at least some of the acceleration intervals.

11. The method of claim 1, further comprising:
moving the component comprises motion within a z-plane; and
wherein the mechanical resonance affects structures governing focus settings for an imaging system positioned to view the object to be imaged.

12. The method of claim 11, wherein:
the structures governing focus settings control the focus of an objective lens aligned along the z-axis orthogonal to the x-y-plane.

13. The method of claim 1, additionally comprising:
determining the mechanical resonance frequency f Hz and setting the starting time, amplitude profile, and time duration of at least some of the acceleration intervals before moving the component.

14. The method of claim 13, wherein:
determining the mechanical resonance frequency f Hz comprises using a simulation program for frequency analysis of solid models.

15. The method of claim 1, wherein:
the time duration for at least one acceleration interval is less than or equal to one half of the time period 1/f seconds.

16. The method of claim 1, wherein:
a portion of the amplitude profile for each acceleration interval has a constant acceleration value.

17. The method of claim 1, wherein:
at least some of the acceleration intervals correspond to negative acceleration of the component.

18. The method of claim 1, wherein:
the mechanical resonance frequency f is between 1 and 250 Hz.

19. The method of claim 1, wherein:
the mechanical resonance frequency f is between 3 and 15 Hz.

20. The method of claim 1, wherein:
the mechanical resonance frequency f is between 7 and 10 Hz.

21. The method of claim 1, wherein:
the plurality of acceleration intervals comprises a first and a second acceleration interval, each with a time duration of less than 1/(2f) seconds, and separated by a time interval with no acceleration, and wherein the amplitude of the second acceleration interval is smaller than the amplitude of the first acceleration interval.

22. The method of claim 1, wherein:
the motion commands have the format of a table relating target position and time.

23. A method for controlling stage motion for a sequencing system, the system comprising 1) a stage to hold a sample containing genetic material, the stage programmable for motion in an x-y plane or an x-y-z plane, and 2) an imaging system comprising a camera and an objective lens aligned along a z-axis orthogonal to the x-y plane to form images of the sample, the system having at least one mechanical resonance with frequency f Hz and time period 1/f seconds, the method comprising:
setting a starting time, amplitude profile, and time duration for at least two acceleration intervals for motion of the stage, wherein the time duration for each of the two acceleration intervals is less than one half of the time period 1/f seconds, and, wherein the amplitude profile indicates an amplitude of the respective acceleration interval over at least a portion of the time duration, and wherein for each first acceleration interval, there is a second acceleration interval with a starting time approximately 1/(2f) seconds after the starting time of the first acceleration interval;
moving the stage of the sequencing system according to the at least two acceleration intervals; and
collecting imaging data from a sample while the stage continues to move.

24. The method of claim 23, further comprising:
determining the mechanical resonance frequency f Hz prior to setting the starting time, amplitude profile, and time duration of at least two acceleration intervals.

25. The method of claim 23, further comprising:
setting a starting time, amplitude profile, and time duration for at least two deceleration intervals for motion of the stage, wherein the time duration for each of the at least two deceleration intervals is less than one half of the time period 1/f seconds, and
for each first deceleration interval, there is a second deceleration interval with a starting time approximately 1/(2f) seconds after the starting time of the first deceleration interval; and
moving the stage of the genetic sequencing system according to the at least two deceleration intervals after imaging data has been collected.

26. The method of claim 25, further comprising:
determining the mechanical resonance frequency f Hz prior to setting the starting time, amplitude profile, and time duration of at least two deceleration intervals.
